(19) United States
(12) Patent Application Publication
(10) Pub. No.: US 2003/0096083 A1
(43) Pub. Date: May 22, 2003

(54) Surface, method for the production therof and an object provided with said surface

(76) Inventors: Robert Morgan, Blender (DE); Gotz Vollweiler, Bremen (DE); Klaus Vissing, Morsum (DE)

Correspondence Address: Neil Steinberg, Steinberg & Whitt, Suite 514, 2672 Bayshore Parkway, Mountain View, CA, 94043, US

(21) Appl. No.: 10/239,101

(22) PCT Filed: Mar. 17, 2001
(86) PCT No.: PCT/EP01/03072

(30) Foreign Application Priority Data
Mar. 20, 2000 (DE) 100 13 748.2
Sep. 22, 2000 (DE) 100 47 124.2

(51) Int. Cl. B32B 1/00

(52) U.S. Cl. 428/141

(57) ABSTRACT

The invention relates to surfaces of objects, in particular containers for receiving liquid, comprising a surface which is extremely hydrophobic and to a method for producing said surface. The invention relates in particular to the suitability of an extremely hydrophobic surface of this type for use in the pouring area of a container for receiving liquid and/or on the inner wall area of a container of this type, whereby liquids can also mean those liquids which already exhibit viscous behaviour (e.g. honey), or are pasty or thixotropic (e.g. ketchup or mayonnaise). The extremely hydrophobic surface can be configured on different materials, such as metal, glass, plastics or ceramics and is also suitable for mass-produced goods and for covering all geometrical shapes. The aim of the invention is to develop a simplified method for producing a self-cleansing, extremely hydrophobic surface, with the objective of providing a reproducible surface that can be configured form various materials and that has a wetting angle with water of no less than 120°, preferably no less than 140°. The invention thus relates to a surface which has an artificial surface structure consisting of elevations and indentations, characterized in that the distance between the elevations is less than 5 μm and that at least the tops of the elevations consist of a hydrophobic material, or have a hydrophobic layer on their exterior.

The subject of the present invention are surfaces of objects, in particular containers for receiving liquid with a surface which is extremely hydrophobic, and a method for producing said surface. The invention describes in particular the suitability of an extremely hydrophobic surface of this type for use in the pouring area of a container for receiving liquid and/or on the inner wall area of a container of this type, whereby liquids can also mean those liquids which already exhibit viscous behavior (e.g., honey), or are pasty or thixotropic (e.g., ketchup or mayonnaise). The extremely hydrophobic surface can be configured on different materials, such as metal, glass, plastics or ceramics and is also suitable for mass-produced goods and for covering all geometrical shapes.

State of the Art, Drawbacks of the State of the Art

The wetting behavior of a surface is determined by two factors:

the surface energy of the solid, which is determined by the chemical composition;

the microscopic, morphological structure of the surface, which depending on texture can support or weaken the repellency behavior of liquids in close dependency on the chemically conditioned surface.

Thus, e.g., in many plants, one observes the effect that certain parts of the plant are completely nonwettable by water, which achieves an advantageous self-cleaning effect for these plants. This phenomenon, known as the lotus effect, is based on the presence of tiny eminences, which can either be wax crystals or wax-covered papillous cell protrusions. These elevations have the effect that drops (such as rain drops) forming on the nonpolar, low-energy wax surface quite easily roll off and pick up and remove any impurities which are present. The lotus effect is described in particular in Barthlott, W. & C. NEINHUIS (1997), “Purity of the sacred lotus, or escape from contamination in biological surfaces,” Planta 202, Pages 1 to 8; BARTHLOTT, W. & Co. NEINHUIS (1998), “Lotus blossoms and automotive paint. Ultrastructure of plant boundary surfaces and biomimetic unsoilable materials,” BIONA-REPORT 12, Proc. Int. Congress GTBB, Pages 281 to 293, Akad. Wiss. Lit. Mainz (Gustav Fischer Verlag), BARTHLOTT, W. & C. NEINHUIS (1998), “Lotus effect and automotive paint. The self-cleaning of microstructurized surfaces,” BiuZ28, Pages 314 to 321.

Effects similar to the lotus effect can also be observed in many textiles, when their fibers have a chemical texture which by itself produces a water wetting angle of >90°. An extremely good repellency behavior is achieved by its interplay with the morphological irregularity of the fiber structure.

There have already been various initiatives for producing self-cleaning surfaces. Thus, for example, EP 0 772 514 B1 describes self-cleaning, hydrophobic layers whose water and dirt-repelling effect is due to surface structures in combination with a hydrophobic chemistry. This lotus effect was observed by the applicant of the aforesaid patent on leaf surfaces of many plants and its implementation for technical products by various methods is the subject of this patent. Thus, it takes into account both the surface structurization, consisting of elevations and depressions of a naturally hydrophobic material, as well as subsequent hydrophobic treatment of a surface-structurized, non-water-repelling material and the application of hydrophobic surface structures to a non-water-repelling material. The size of the effective surface structures is explicitly set at a range of 5 μm to 200 μm, i.e., the distance from one elevation to another lies in the range of 5 μm to 200 μm.

A product which relies on the teaching of the aforesaid European patent is apparently the “Lotusan” exterior paint of the firm Ispo GmbH, Kriftel.

EP 0 909 747 describes the production of self-cleaning, water-repellent bricks by the dispersing of inert powder articles that are wetted with a siloxane solution, which is subsequently hardened. Here as well the water repellent effect is achieved by the interplay of surface structure and hydrophobia. The size of the surface structure is determined to be 5 μm to 100 μm.

U.S. Pat. No. 3,354,022 describes a method of hydrophobic treatment of surfaces by spraying on a paraffin solution or dispersion. Volatilization of the dispersant or solvent produces wax eminences of 50 μm to 80 μm diameter at a mutual distance of 20 μm to 160 μm.

CH-PS 26 82 58 describes water repellent surfaces which are produced by applying previously hydrophobic-treated ceramic powder together with hardenable resin onto a surface.

A further initiative for production of self-cleaning surfaces consists in the preparation of photocatalytically active surfaces, e.g., by coating with TiO₂, in which case the accumulated impurities are chemically broken down by action of the catalyst when exposed to light. This is described in Fujishima, A.; Hashimoto, K.; Watanabe, T,: TiO₂ Photocatalysis—Fundamentals and Applications, BkC Inc., Tokyo, ISBN4-939051-03-X.

Hydrophobic surfaces can also be produced by a special plasma polymerization technique (DE 195 43 133 C2). Large-scale implementation, however, is not possible, especially in regard to the stated purpose. Furthermore, no structurizing of the surface is utilized.

Finally, reference shall also be made to European patent EP 0 453 897, which describes the preparation of a self-cleaning coating for oven walls.

Purpose

The immediate purpose of the invention is to develop a simplified method for creation of self-cleaning, extremely hydrophobic surface. If possible, one should also achieve the goal of providing a reproducible surface which can be formed from various materials and which has a contact angle of not less than 120°, preferably not less than 140°, with water.

Furthermore, an additional purpose should be achieved, namely, to greatly improve the pouring behavior of containers which can hold liquids.

Finally, the purpose should be achieved of providing attractive, transparent containers which prevent the material kept in them from sticking to the inner walls of the container.

The Invention

The various purposes are achieved by the invention with the features of claims 1, 9, 17, 20, 21, 22. Further advantageous embodiments are described in the subsidiary claims.

The influence of the surface structure in combination with the chemical nature is already known, but thus far only surface structures with size over 5 μm have been considered. Surprisingly, it has now been found that even irregular surface structures with a size less than 5 μm, preferably under 4 μm or 2 μm, can produce an excellent self-cleaning effect.

The invention is based on the recognition that self-cleaning surfaces, even those which are known from the state of the art, can be used in excellent fashion to improve the pouring behavior of containers if a self-cleaning surface is formed in the pouring zone, which then dramatically reduces the force of adhesion acting on the liquid when it is poured out.

Especially suitable in this case is a self-cleaning surface whose surface structures are smaller than 5 μm. This is all the more surprising because EP 0 772 514 expressly points out that the self-cleaning surface effect cannot be demonstrated for surface structures lying below 5 μm. Therefore, it also proposes surface structures lying in the range of 10 μm to 100 μm as being optimal.

The other patents such as EP 0 909 747 or U.S. Pat. No. 3,354,022 also describe surface structures whose size is always above 5 μm.

By fashioning the hydrophobic surface according to the invention in the pouring region of a container, the pouring behavior of such a container is improved in that liquid drops are prevented from getting onto the container outside (by minimizing the force of adhesion occurring there). Thus, a technical solution is provided which eliminates the millennia-old problem, namely, preventing the unwanted dripping of drops on the outside of a container during or after pouring liquid out from the container. This improved pouring effect can be achieved independently of the basic material used for the container and also even when the surface structure has a size in the range of 0.1 μm to 200 μm.

Finally, the invention also proposes not applying a self-cleaning surface as a paint—as with Lotusan—but instead making the extremely hydrophobic surface in two consecutive steps, which is often easier and more reliable in the production engineering. In the first step, a suitable morphological surface structure is produced. This can occur, for example, by fine blasting, or also by other techniques such as embossing or etching. Preferably, the morphological surface structure is produced by (fine) blasting of the surface with suitable blasting material (e.g., corundum with granularity of 0.125 mm to 0.35 mm; blasting material with sharp-edged grains is especially suitable). In this way, one can create a surface with the desired surface structure (irregular surface) characterized by eminences and depressions, which forms a suitable base for the coating to be applied in the later (second) step.

The choice of the blasting material and the parameters used depend on the given substrate material, which can be either polymer, metal, or ceramic in structure. The critical fact is that the blasting material brings about the formation of a fine-rough surface structure of size from the range of less than 200 μm, which is preferably accomplished by sharp grains. Furthermore, it is important that the material not be shattered by the processing, which is especially important with plastic. The blasting material itself should not dwell in the processed surfaces, in order to assure a good adhesion of the subsequent coating, so that a cleaning of the surface structure is advisedly included after the blasting step.

The blasting step should be done so that not too much material is removed by excessive processing, such that the PE might be removed in the case of a throwaway beverage package made from cardboard coated with PE. It should merely be structurized.

If the configuring or creation of the suitable morphological surface structure is done by embossing, this can be done for example with an embossing stamp, which is also possible at room temperatures, if the substrate is, for example, the surface of a package, e.g., a traditional milk container.

The second step for production of the hydrophobic surface consists in applying a contour-following coating, which when applied to smooth substrates would have a wetting angle between 90° and 120°. This coating can also have other functions, such as corrosion protection, or also a sealing effect.

The contour-following coating should be distinguished in particular by a low surface energy and can be applied, for example, by the method of plasma polymerization. As an option, one can use methods at low pressure, or also atmospheric pressure. As an alternative or in addition to the plasma polymerization, one can also consider processes such as the sol-gel method, siliconization, teflonization, or other methods.

The contour-following coating is characterized as follows:

in its chemical composition, it is chosen so that it would produce with water on an already perfectly smooth surface preferably a contact angle of more than 90°.

its thickness is so slight that it does not cover over the critical morphological surface structures—which were produced in the first step—and therefore does not make them inactive, or the contour is followed independently of layer thickness, according to the method.

When producing the contour-following coating with plasma polymerization, a gas of suitable chemical composition (e.g., HMDSO) is ignited as plasma and thus activated. As a result, a layer is deposited on a presented substrate, in the present case on the structurized surface (after the first step). The contour-following coating can be applied to all types of material and has equally good adhesion, to all of them. This can be explained in terms of process technology in that the reactive particles created in the plasma chemically bind to them. The preservation of the surface structures is guaranteed. Thus, the layer thickness can be in the range of 0.1 nm to 400 nm, preferably in the range of 1 nm to 50 nm, and can also be applied with exact definition of its thickness.

The contour-following coating can be formed in closed manner on the already structurized surface, yet it does not by any means need to be closed. A closed coating can be expected in layer thickness ranges of around 5 nm to 50 nm. But only partial coatings (e.g., only on the eminences) also already exhibit the desired hydrophobic effect of the invention, which is especially the case with a “uniform” partial coating.

The layer thickness of the contour-following coating can be basically constant, yet it is also quite possible for the layer thickness to be different at the eminences and depressions and for the layer thickness to be greater on the eminences, especially their exposed parts in cross section, than the layer thickness at the depressions.

The advantage of the invented method is the very simple preparation of extremely hydrophobic surfaces on materials of the most diverse geometry and material texture, even with combinations of materials.

For the application of the improvement in the pouring behavior for liquid-receiving containers it is important to select an in-line capable process technology, as well as a coating process which is permissible for food-fast and washing machine-resistant coatings. Therefore, embossing and blasting are particularly suited for the surface structurizing, and the atmospheric pressure plasma process for the coating.

In order to define the sealing capability of the coated material (which is especially important for disposable packages), a very slight, extensively closed coating with a layer thickness of around 1 nm to 20 nm, preferably 5 nm to 10 nm, is selected. The sealing force can be adjusted specifically in terms of the layer thickness of the (plasma-polymer) coating between no change relative to the uncoated material (low layer thicknesses of 1 nm to 10 nm) and no sealing capability (large layer thickness above 100 nm).

The sealing force is especially important, for example, when a package such as a standard milk package of Tetra-Pack® has two layers of packaging material one on top of the other (coated paper) that are joined together and that also need to be sealed at the same time.

By adjusting the sealing force it is also possible to adjust the tear-open behavior of a package, preferably a disposable package, so that it can be better separated from each other at the predetermined tear-open locations, while also providing a sufficient sealing of the liquid in the unopened condition.

With the described hydrophobic surface according to the invention it is not only possible to accomplish a self-cleaning, but also improve the pouring behavior of articles in which liquids or flowable foodstuffs are kept. This includes, for example, bottles, milk canisters (ceramic), coffee or tea pots (glass), disposable juice or milk packs (coated paper), ketchup or sauce bottles, etc. The liquids being poured out bead on the strongly hydrophobic surface due to the slight interaction and can thus be easily detached from it. Thus, the customary lips of pouring vessels are unnecessary. Even plastic dispensers, which have become known as Tetra-Pack® packages in recent time, can be replaced by the invention, which means an especially favorable production of disposable juice or milk packs, yet the manufacturer's price for a dispenser according to the invention is substantially below that of dispensers of modem Tetra-Pack® packages, in which a plastic bottle cap is provided, covering a tear-off aluminum strip, which has to be detached in order to empty the package.

In a disposable juice or milk package according to the invention, on the other hand, the hydrophobic surface can be placed on the outside of the package, for example, in the top part of the package. It is preferably prepunched in the pouring area, so that it can easily be pressed inward or the corresponding piece can be torn off. If the described hydrophobic surface surrounds the pouring opening, none of the liquid poured out can get caught and retained on the outer margin, but instead all of the liquid is poured out and there is no undesired dripping on the outside of the package.

For better hygienic closure of such a disposable package, it can also be provided that it also has an adhesive cover, which is designed to be detached at one side of the package and which after partly emptying the package can be stuck back onto the package with the detached side, so that the pouring opening is closed virtually air-tight (or totally airtight), such that even if the package is accidentally tilted the escape of liquid is prevented as much as possible.

The invented hydrophobic surface can also be a streamline surface covering the outer skin of an airplane or a vehicle of any kind (railway, automotive, ship, bicycle, boat, canoe, sports boat, surfboard) or the inner wall of a pipeline of any kind.

The formation of the hydrophobic surface not only improves the flow behavior in general, i.e., it lowers the flow resistance, which entails a lower output of energy (or higher speed for the same output) to move the particular vehicle, but can also save considerable fuel during rainy weather, because the raindrops striking the aircraft or vehicle are wiped away considerably faster with the relative wind. It is also advisable to apply the described hydrophobic surface of the invention to the outer walls of ships, especially in the underwater area, in order to lower the friction between water and the ship.

The use of the invented surface also makes it possible to avoid icing on aircraft and other objects undergoing rapid movement through the air. The rain, for example, which falls on or strikes against a flying aircraft and is carried along by it has a greater tendency to evaporate, which results in an additional latent heat on the upper skin of the aircraft, which then sustains an “instant” icing of the affected surface (storm ice). The formation of a strongly hydrophobic surface according to the present invention, especially in cooperation with the high air speed, ensures that the water droplets immediately leave the surface again, so that the problem of the latent heat and icing does not even arise. Thus, the aircraft is lighter on the whole and it also therefore requires less energy to fly. The same holds for the formation of the invented surface on the rotor blade of a wind energy layout.

Finally, the invented surface can be used generally wherever objects come into contact with liquids or powders and where it is desired to reduce and/or minimize the adhesion between the liquid or the dust and the object. This is the case, for example, with a liquid conduit, such as a pipeline.

The invention shall be explained hereafter by means of several sample embodiments.

### EXAMPLE 1

A surface of aluminum (AlMg3SiO.5) is uniformly blasted with corundum material. The workpiece is then cleaned in ethanol in an ultrasound bath and after drying it is placed in a plasma reactor. Here, the aluminum surface is provided with a plasma-polymer coating according to the state of the art.

The resulting surface has a very fine structurized, irregular with extremely hydrophobic nature. The following H₂O wetting angles (α) result:

| Surface | Wetting angle, Contact angle |
|---|---|
| Aluminum, untreated | 71° |
| Aluminum, unblasted | 93° |
| plasma-polymer coated | |
| Aluminum, blasted, | 156° |
| plasma-polymer coated | |

### EXAMPLE 2

A workpiece of PMMA is blasted as in Example 1, cleaned in ultrasound, and provided with a plasma-polymer coating according to the state of the art. The following H₂O wetting angles result:

| Surface | Contact angle |
|---|---|
| PMMA, untreated | 66° |
| PMMA, unblasted, | 92° |
| plasma-polymer coated | |
| PMMA, blasted, | 145° |
| plasma-polymer coated | |

### EXAMPLE 3

PE coated carton (milk package) is blasted as in Example 1, blown off with pressurized air and provided with a plasma-polymer coating according to the state of the art. The following H₂O wetting angles result:

| Surface | Contact angle |
|---|---|
| PE, untreated | 66° |
| PE, unblasted, | 92° |
| plasma-polymer coated | |
| PE, blasted, | 145° |
| plasma-polymer coated | |

With the invention it is also possible not only to provide the pouring area of liquid-receiving containers with an extremely hydrophobic surface, but also the inner walls of these containers. This means that even when containing viscous or thixotropic substances (liquids), they do not get stuck on the inside of the wall when the container is partially emptied, for example, but instead the material remaining in the container, even that which initially got stuck to the inner wall, drains downward as much as possible, so that the container, if transparent, has a very esthetically pleasing exterior to the viewer. This also results in improved hygiene, because the contact surface between the material, such as ketchup, mustard, sauce, etc., or another flowable foodstuff in the container and the air is minimal and no germs can form on the inner wall or the material residue remaining there. As a simple example of this, take a transparent bottle, such as one made of glass or plastic to contain ketchup or sauce. Thanks to the improved pouring behavior, this food material does not remain either in the pouring area or on the inner wall, so that even when the ketchup or sauce bottles are half empty they still provide a very attractive impression, which is in no way the usual impression of bottles which are soiled on the inside.

With the invention, thus, the complete emptying of such bottles is also possible, which was seldom the case heretofore, because residue of ketchup or sauce always remained in the bottles. Also, the pouring behavior of viscous foodstuffs like ketchup or sauce is improved overall.

The invention shall also be explained more closely hereafter by means of figures and photographs. These show:

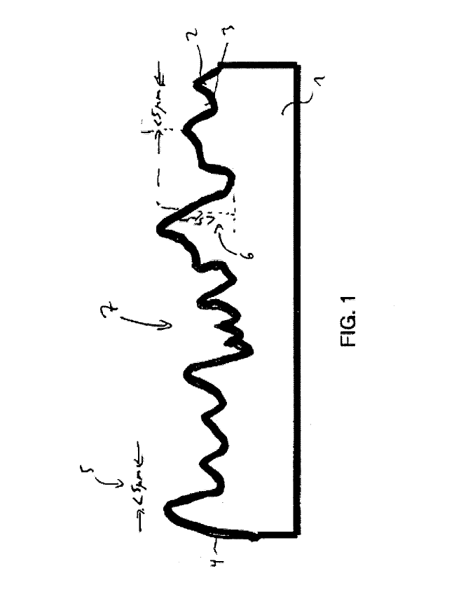

FIG. 1 a cross section through a surface according to the invention;

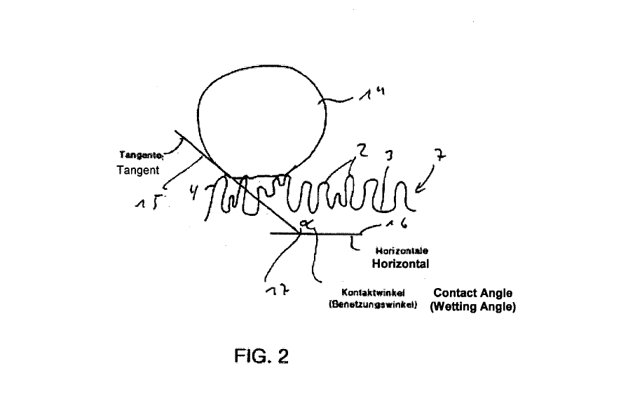

FIG. 2 a cross section through a surface according to the invention with a water drop lying on it;

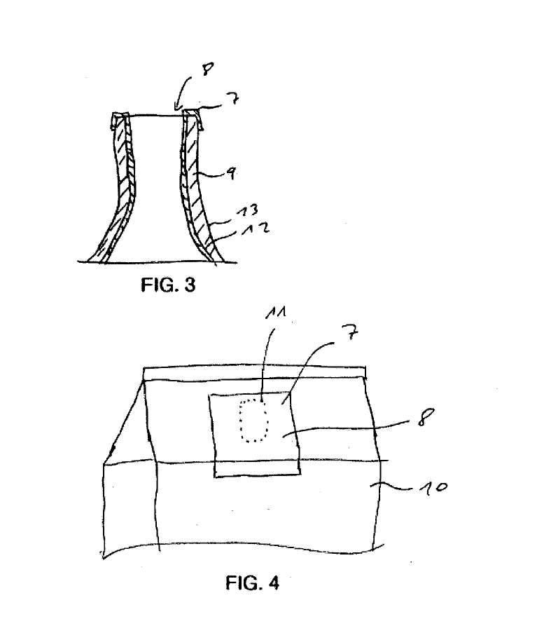

FIG. 3 a cross section through the upper part of a bottle in cross section with a surface according to the invention applied to the inside and outside;

FIG. 4 a top view of the upper part of a milk package, with a surface according to the invention partially applied there;

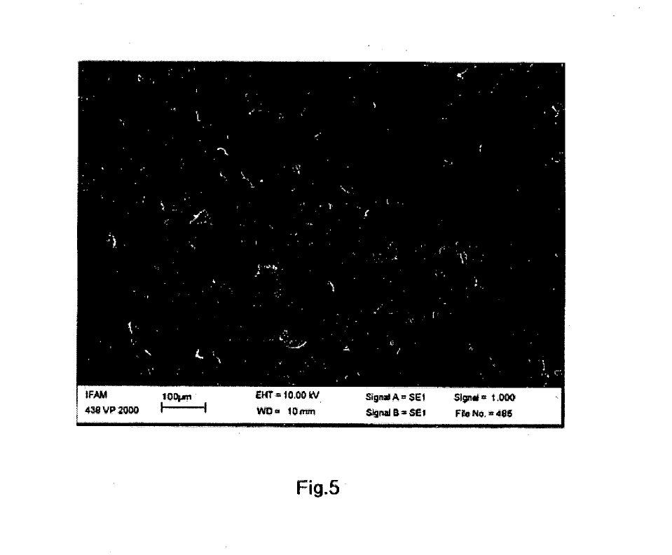

FIG. 5 a microscopic photograph of a nonblasted carton of a package;

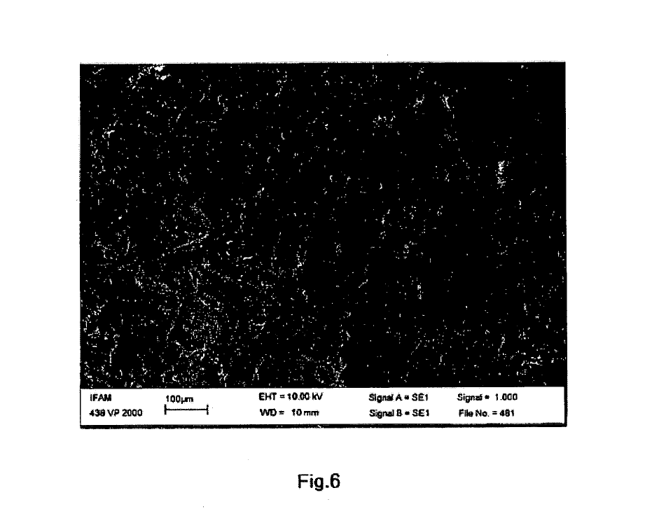

FIG. 6 a microscopic photograph of a structurized surface according to the invention; and

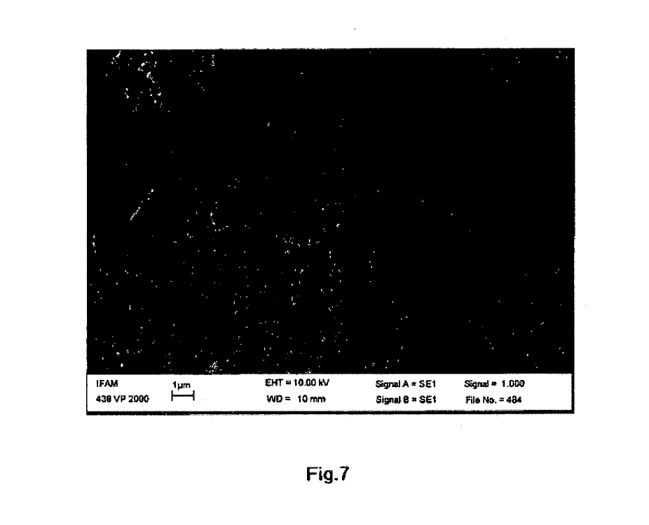

FIG. 7 a microscopic photograph (enlarged view of FIG. 6) of a structurized surface according to the invention.

FIG. 1 shows a surface 7 according to the invention, which is formed on a substrate 1, consisting for example of plastic, glass, ceramic or metal. As can be seen in the profile view of FIG. 1, the surface consists of eminences 2 and depressions 3. The interval between neighboring eminences (on average) is less than 5 μm, measuring, for example, the distance between eminences from peak to peak, being projected onto a common line. The height of the eminences is also preferably less than 5 μm, in which case the height of the eminences, is measured, for example, from the peak of an eminence to the lowest nearby level of depression.

As can be seen in FIG. 1, the surface 7 so structurized (morphological surface structure) is not uniform, although neither is that precluded, but instead it is irregularly structurized, and the intervals between neighboring eminences 5 are also regularly different. The same applies to the height 6 of neighboring eminences.

As FIG. 1 shows, a contour-following layer 4 is applied to the morphological surface structure of the substrate 1, consisting of a preferably extremely hydrophobic material. The chemical composition of this coating is chosen so that even on a totally planar surface it would already form with water a contact angle of more than 90°.

While the structurizing of the surface in the substrate 1 can be done by the above-described methods (first step), the coating of the layer 4 is preferably done by a plasma polymerization, wherein the coating material is deposited onto the eminences and depressions. The layer thickness is under 500 nm, preferably in the range of 0.1 nm to 300 nm. Especially good results were achieved in tests with a layer thickness of more than 7 nm.

If the surface represented in profile in FIG. 1 is wetted with a drop of water 14—see FIG. 2—it will form an almost ideal sphere there. Between the surface 7 and the sphere a contact angle or wetting angle is produced which is much larger than 120°, e.g., 140° or more. The contact angle is measured by erecting a tangent on the water drop surface and the contact of the surface 7 and a horizontal line 16.

Thanks to the thus increasing large contact angle, the water drop has a tendency to easily bead off the surface. In any case, the adhesion between water drop and surface is extremely slight and many times less than when the water drop is placed on a flat surface, e.g., a glass surface, in which case a contact angle of much less than 90° (e.g., 45°) usually occurs.

FIG. 3 shows the cross section through the upper part of a liquid-receiving container, e.g., a bottle 9. This bottle 9 consists of glass with an inner wall 12 and an outer wall 13, as well as a pouring region 8, also customarily termed the bottle opening. In the represented example, the hydrophobic surface 7 is formed both on the inside of the bottle and in the pouring region and it also extends somewhat beyond the upper rim of the bottle.

If, now, the liquid, such as water, in the bottle is poured out, it is easily detached from the surface 7, so that not even one or more drops run down on the outer wall 13 of the bottle when the bottle is tilted back into the vertical position—as is otherwise the case. Also the liquid located on the inside wall 12 of the bottle cannot remain there, due to the low force of adhesion, and it drains downward until the liquid remaining in the bottle has reached its maximum fill level.

If the liquid is rather viscous, such as a salad dressing or ketchup, this also drains off from the inside due to the surface 7 which has been formed, so that one looking at the bottle has the impression that it is clean on the inside. This quite considerably improves the esthetic impression of just such liquid-containing receptacles when they are to be used in the food preparation sector.

FIG. 4 shows, as the liquid-receiving container, the upper part of a disposable milk package (milk carton). This milk package is folded to produce it, and the packaging material is generally coated paper. In the upper area of the milk carton, it has a roof, for example, whose upper edge generally has material layers joining together, which are folded and glued together and/or sealed.

In the roof region, an area 8 is formed with the hydrophobic surface 7. In the depicted example, there is a perforation 11 within this area 8. If necessary, it can also penetrate into the area 8 only with its lower part. This perforation (it can also be a prepunching, without breaking through the material at this site) serves to allow the roof of the package to be easily broken through at this site and the preperforated area can be pushed in or torn off. Now the milk located in the package can be poured out, and because of the formation of the surface 7 in the pouring region of the milk package no milk can run down onto the outside of the milk package when the pouring angle is very slight.

FIG. 5 shows a microscopically enlarged photograph of a milk packaging carton in the original condition (without blasting). As can be seen, the surface is not uniformly structurized and is totally flat in broad areas.

FIG. 6 shows the microscopically enlarged depiction of the outside of the carton in the pouring region in the condition after creating the structurized surface according to the invention. As can be seen, the surface structure is not only extremely irregular, but it is also characterized by a large number of eminences and depressions distributed over the entire area.

FIG. 7 shows yet another microscopically enlarged view of the surface 7 per FIG. 6. From the scale shown at the bottom of the figure one can recognize the fact that an extremely ununiformly structurized surface has been formed once again, and the intervals between neighboring eminences are much less than 5 μm.

The structurized surfaces shown in FIGS. 6 and 7 were produced by (fine) blasting. Such a structurization of the surface, however, is also possible with engraving or embossing stamp or also by an etching of the surface, as is shown in FIG. 5.

The surface according to the invention can also be formed on the inside of a freezer or refrigerator or on the inner wall of a cold storage or freezer compartment. This will prevent ice from building up, which thus far leads to long down times for freezers, refrigerators, cold storage or freezer compartments.

1. Surface having an artificial surface structure of eminences and depressions, characterized in that the distance between the eminences is less than 5 μm and at least the eminences on top consist of a hydrophobic material or have a hydrophobic layer on the outside.

2. Surface per claim 1,
characterized in that the height of the eminences is less than 5 μm, preferably less than 2 μm.

3. Surface per claim 1 or 2,
characterized in that a layer of preferably hydrophobic material emulating the eminences and depressions is applied to the eminences and depressions, the thickness of the layer being free to select, and preferably lies in the range of 0.1 nm to 300 nm.

4. Surface per claim 3,
characterized in that the layer on the surface structure is not closed.

5. Surface per claim 3,
characterized in that the layer thickness is different on the eminences and the depressions and the layer thickness on the eminences, at least their exposed parts, is larger on average than the layer thickness on the depressions.

6. Surface according to one of the preceding claims,
characterized in that the layer formed on the eminences and/or depressions consists of a food-fast and/or washing machine-resistant material.

7. Surface according to one of the preceding claims,
characterized in that the contact angle which a water drop forms when lying on the surface is greater than 120°, preferably greater than 140°.

8. Surface according to one of the preceding claims,
characterized in that the surface is formed in the pouring region of a liquid-receiving container and/or on the inner wall of the container.

9. Method for production of a structurized, hydrophobic surface of eminences and depressions, wherein the interval between the eminences is less than 200 μm, lying preferably in the range between 0.1 μm and 5 μm, wherein the method is characterized by the following steps:
creation of a surface structure by mechanical and/or chemical treatment of a surface with little or no structurization prior to this, wherein the surface structure after being created has eminences and depressions and the eminences have a spacing which is less than 200 μm, lying preferably in the range between around 0.1 μm and 5 μm (first step);
application of a contour-following coating to the previously created artificial surface structure, wherein the layer thickness is free to select, lying preferably in the range of around 0.1 nm to 300 nm (second step).

10. Method per claim 9,
characterized in that the height of the eminences is less than 100 μm, preferably less than 5 μm.

11. Method per claim 10,
characterized in that the contour-following coating is applied by a plasma polymerization process (low pressure or atmospheric pressure).

12. Method according to one of the preceding claims,
characterized in that in the first step the surface structure is created by (fine) blasting of the surface with suitable blasting material and/or embossing with an appropriate embossing stamp or etching by means of a suitable etching material.

13. Method per claim 12,
characterized in that, when creating the surface structure by (fine) blasting, the blasting material is a corundum with a granularity of around 0.125 mm to 0.5 mm, preferably 0.125 mm to 0.35 mm.

14. Method according to one of the preceding claims,
characterized in that any blasting material still remaining in the surface structure after the first step is removed, for which the use of pressurized air is preferably suited.

15. Method according to one of the preceding claims,
characterized in that the contour-following coating is applied by a sol-gel method and/or a siliconization and/or a teflonization and/or other thin film coating technologies.

16. Method for improving the pouring behavior of liquid-receiving containers by formation of an artificial surface structure of eminences and depressions in the pouring region of the container, wherein the interval between the eminences is less than 200 μm, preferably lying in the range of around 0.1 μm to 5 μm.

17. Use of surfaces with an artificial surface structure of eminences and depressions, wherein the interval between the eminences is less than 200 μm, preferably lying in the range of around 0.1 μm to 5 μm, and at least the eminences consist of a hydrophobic material and/or are coated with such a hydrophobic material to improve the pouring behavior of containers by forming the surface in the pouring region of the containers.

18. Use of a hydrophobic surface, especially according to one of the preceding claims, to define the sealing force between two sealed layers of material, for example, two layers of material of a disposable package, one on top of the other, which are sealed together.

19. Use per claim 18,
characterized in that the sealing force is adjusted in terms of the layer thickness of the contour-following coating.

20. Liquid-receiving container, which is provided with a surface according to one of the preceding claims in the pouring region.

21. Liquid-receiving container or conduit, consisting of an inner and outer wall, wherein a surface according to one of the preceding claims is formed on all or part of the inner wall.

22. Means of transportation whose skin or other parts (e.g., bumpers) are provided totally or partly with a surface according to one of the preceding claims.

23. Method for making a structurized, hydrophobic surface of eminences and depressions, wherein the interval between the eminences is less than 2 μm, preferably lying in the range between 0.1 μm and 5 μm, characterized in that a hydrophobic coating is applied to a substrate and during the coating a lattice structure is placed on the substrate, which when removed leaves behind eminences and depressions, the interval between the eminences being less than 2 μm, preferably in the range between 0.1 μm and 5 μm.
